(19) United States
(12) Patent Application Publication
(10) Pub. No.: US 2013/0044032 A1
(43) Pub. Date: Feb. 21, 2013

(54) ANTENNA

(71) Applicant: CHIA-CHING WU, Tu-Cheng (TW)

(72) Inventor: CHIA-CHING WU, Tu-Cheng (TW)

(73) Assignee: HON HAI PRECISION INDUSTRY CO., LTD., Tu-Cheng (TW)

(21) Appl. No.: 13/223,299

(22) Filed: Aug. 31, 2011

(30) Foreign Application Priority Data
Aug. 19, 2011 (TW) 100129672

(51) Int. Cl. H01Q 1/24

(52) U.S. Cl. 343/702

(57) ABSTRACT

An antenna includes a metal housing, a ground, a coupling feeder, and a coupling ground. The metal housing is a housing of an electronic device. The ground is integrated with the metal housing and is connected to a circuit board of the electronic device through a first conductor. The coupling feeder is connected to the circuit board of the electronic device through a first capacitor and a second conductor. The coupling ground is connected to the circuit board of the electronic device through a second capacitor and a third conductor.

### BACKGROUND

1. Technical Field

The present disclosure relates to an antenna for being used in an electronic device with metal housing.

2. Description of Related Art

Generally, electronic communication devices must include an antenna. Often the antenna is placed inside the devices to make them more compact, which takes up precious limited internal space of the electronic device. Further, to provide strong electronic devices, metal housings are often used. However, the metal housing can negatively influence the performance of the antenna.

### BRIEF DESCRIPTION OF THE DRAWINGS

The components of the drawings are not necessarily drawn to scale, the emphasis instead being placed upon clearly illustrating the principles of the present disclosure. Moreover, in the drawings, like reference numerals designate corresponding parts throughout several views.

FIG. 1 is an isometric view of an antenna in accordance with an exemplary embodiment.

FIG. 2 is a schematic view of a first capacitor of the antenna of FIG. 1.

FIG. 3 is a schematic view of a second capacitor of the antenna of FIG. 1.

FIG. 4 is a circuit diagram of the antenna of FIG. 1.

### DETAILED DESCRIPTION

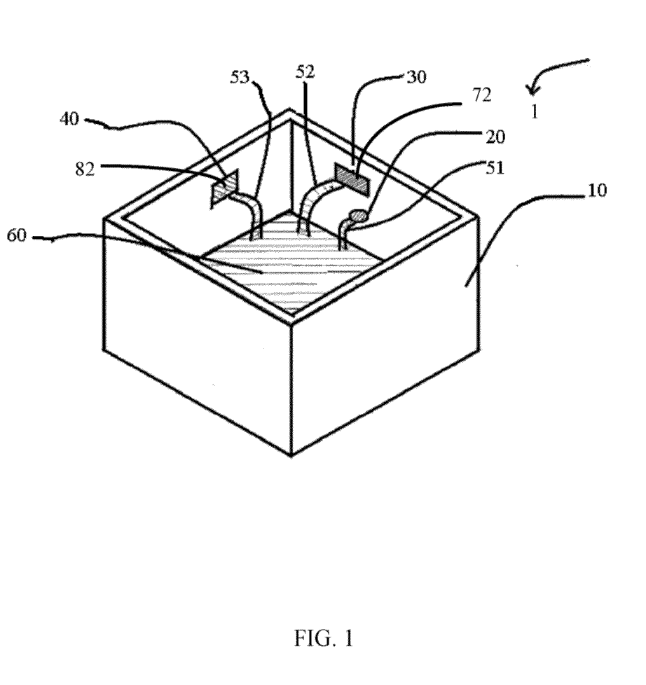

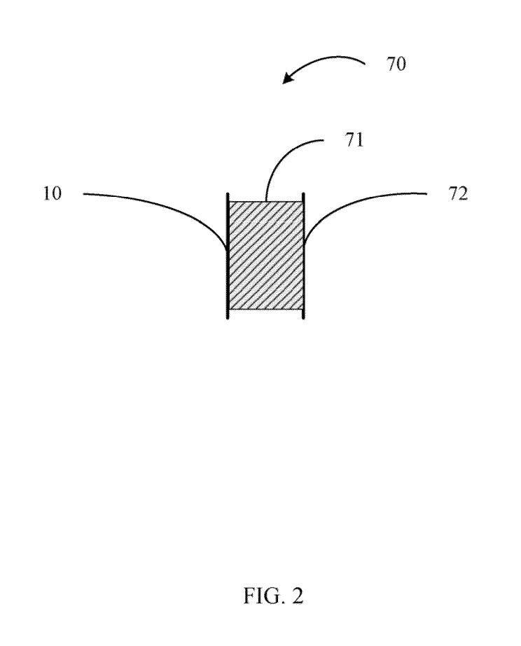

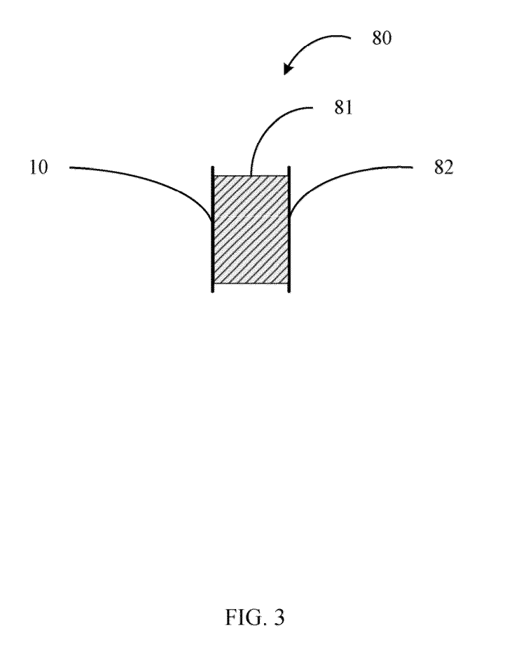

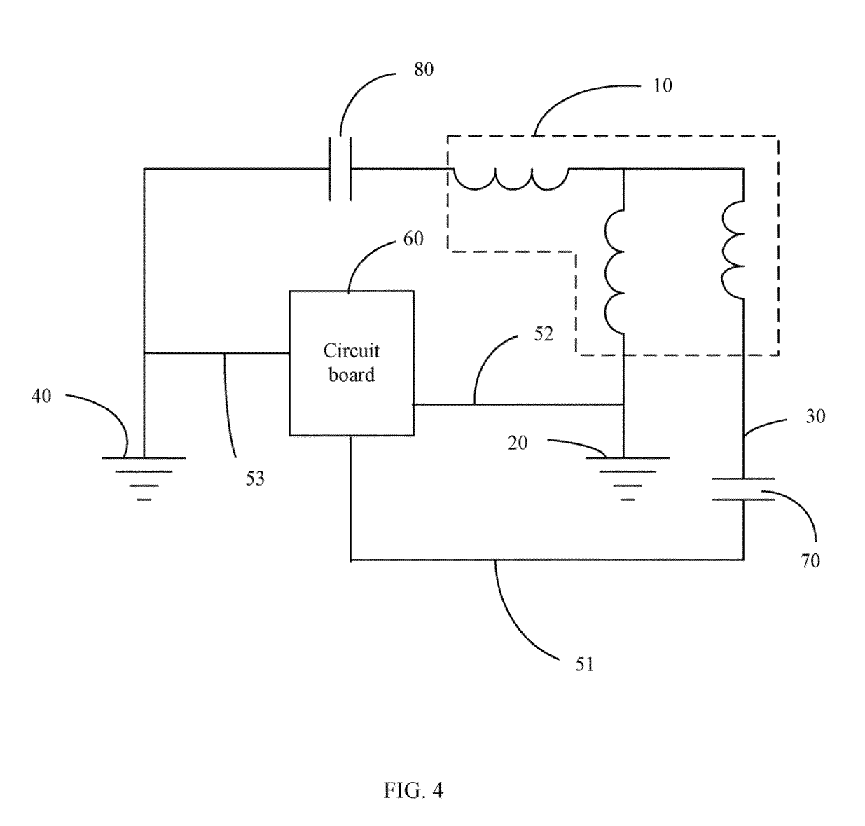

Referring to FIGS. 1-4, an antenna 1 includes a metal housing 10, a ground 20, a coupling feeder 30, and a coupling ground 40. The metal housing 10 is a housing of an electronic device (not shown). The ground 20 is integrated with the metal housing 10 and is connected to a circuit board 60 of the electronic device through a first conductor 50. The coupling feeder 30 integrates with the metal housing 10 for receiving RF signals and is connected to the circuit board 60 of the electronic device through a first capacitor 70 and a second conductor 51. The first capacitor 70 is formed by a first insulator 71 sandwiched by a first metal sheet 72 and the metal housing 10. The first capacitor 70 is for transmitting RF signals received by the coupling feeder 30 to the circuit board 60 to processing or for transmitting the signal outputted by the circuit board 60 to the coupling feeder 30 to radiate to the air. The coupling ground 40 is connected to the circuit board 60 of the electronic device through a second capacitor 80 and a third conductor 53. The second capacitor 80 is formed by a second insulator 81 sandwiched by a second metal sheet 82 and the metal housing 10. The second capacitor 80 is for reducing noise.

In the exemplary embodiment, the first insulator 71 and the second insulator 81 are made of glue with insulative properties.

In the exemplary embodiment, the coupling ground 40 is placed on one inner surface of the metal housing 10. The ground 20 and the coupling feeder 30 are placed on another inner surface of the housing 10 adjacent to the surface where the coupling ground 40 is placed. In other embodiment, placement of the ground 20, coupling feeder 30, and coupling ground 40 can be changed according to need.

In this embodiment, tuning of the antenna can be adjusted by adjusting a distance between the ground 20 and the coupling feeder 30 and by adjusting a distance between the coupling ground 40 and the coupling feeder 30.

In this embodiment, the first insulator 71 and the first metal sheet 72 which forms the first capacitor 70, and the second insulator 81 and the second metal sheet 82 which forms the second capacitor 80 together form a flexible printed circuit (FPC). The size of the FPC is selected according to the desired level of capacitive coupling of the first capacitor 70 and the second capacitor 80. In other words, the level of capacitive coupling is proportionate to the size of the FPC.

In this embodiment, the first conductor 50, the second conductor 51, and the third conductor 52 are metal elastic sheets.

Although, the present disclosure has been specifically described on the basis of preferred embodiments, the disclosure is not to be construed as being limited thereto. Various changes or modifications may be made to the embodiment without departing from the scope and spirit of the disclosure.

What is claimed is:

1. An antenna comprising:
a metal housing;
a ground integrated with the metal housing and connected to a circuit board of the electronic device through a first conductor;
a coupling feeder connected to the circuit board of the electronic device through a first capacitor and a second conductor; and
a coupling ground connected to the circuit board of the electronic device through a second capacitor and a third conductor.

2. The antenna as described in claim 1, wherein the first capacitor is formed by a first insulator sandwiched by a first metal sheet and the metal housing, the second capacitor is formed by a second insulator sandwiched by a second metal sheet and the metal housing.

3. The antenna as described in claim 2, wherein the first insulator and the second insulator are made of glue with insulative properties.

4. The antenna as described in claim 2, wherein the first insulator and the first metal sheet which forms the first capacitor, and the second insulator and the second metal sheet which forms the second capacitor together form a flexible printed circuit (FPC). The size of the FPC is selected according to the desired level of capacitive coupling of the first capacitor and the second capacitor.

5. The antenna as described in claim 1, wherein tuning of the antenna is achieved by adjusting a distance between the ground and the coupling feeder and by adjusting a distance between the coupling ground and the coupling feeder.

6. The antenna as described in claim 1, wherein the coupling ground is placed in one inner surface of the metal housing, the ground and the coupling feeder is placed in another inner surface adjacent to the inner surface where the coupling ground is placed.
